(19) United States
(12) Patent Application Publication
(10) Pub. No.: US 2010/0138736 A1
(43) Pub. Date: Jun. 3, 2010

(54) DELIVERING MULTIMEDIA DESCRIPTIONS

(75) Inventor: Ernest Yiu Cheong Wan, Carlingford (AU)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/697,975

(22) Filed: Feb. 1, 2010

Related U.S. Application Data
(62) Division of application No. 10/296,162, filed on Jun. 3, 2003.

(30) Foreign Application Priority Data
Jul. 10, 2000 (AU) PQ8677

(51) Int. Cl. G06F 17/00

(52) U.S. Cl. 715/234

(57) ABSTRACT

A method of processing a document described in a mark up language, for example XML, is disclosed. A structure and a text content of the document are separated, and then the structure is transmitted before the text content, for example, by streaming. Parsing of the received structure is commenced before all of the text content is received. Also disclosed is a method of forming a streamed presentation from at least one media object having content and description components. A presentation description is generated from at least one component description of the media object and is processed to schedule delivery of component descriptions and content of the presentation to generate elementary data streams associated with the component descriptions and content.

### TECHNICAL FIELD OF THE INVENTION

The present invention relates generally to the distribution of multimedia and, in particular, to the delivery of multimedia descriptions in different types of applications. The present invention has particular application to, but is not limited to, the evolving MPEG-7 standard.

### BACKGROUND ART

Multimedia may be defined as the provision of, or access to, media, such as text, audio and images, in which an application can handle or manipulate a range of media types. Invariably where access to a video is desired, the application must handle both audio and images. Often such media is accompanied by text that describes the content and may include references to other content. As such, multimedia may be conveniently referred to as being formed of content and descriptions. The description is typically formed by metadata which is, practically speaking, data which is used to described other data.

The World Wide Web (WWW or, the “Web”) uses a client/server paradigm. Traditional access to multimedia over the Web involves an individual client accessing a database available via a server. The client downloads the multimedia (content and description) to the local processing system where the multimedia may be utilised, typically by compiling and replaying the content with the aid of the description. The description is “static” in that usually the entire description must be available at the client in order for the content, or parts thereof, to be reproduced. Such traditional access is problematic in the delay between client request and actual reproduction, and the sporadic load on both the server and any communications network linking the server and local processing system as media components are delivered. Real-time delivery and reproduction of multimedia in this fashion is typically unobtainable.

The evolving MPEG-7 standard has identified a number of potential applications for MPEG-7 descriptions. The various MPEG-7 “pull”, or retrieval applications, involve client access to databases and audio-visual archives. The “push” applications are related to content selection and filtering and are used in broadcasting, and the emerging concept of “webcasting”, in which media, traditionally broadcast over the airways by radio frequency propagation, is broadcast over the structured links of the Web. Webcasting, in its most fundamental form, requires a static description and streamed content. However webcasting usually necessitates the downloading of the entire description before any content may be received. Desirably, webcasting requires streamed descriptions received with or in association with, the content. Both types of applications benefit strongly from the use of metadata.

The Web is likely to be the primary medium for most people to search and retrieve audio-visual (AV) content. Typically, when locating information, the client issues a query and a search engine searches its database and/or other remote databases for relevant content. MPEG-7 descriptions, which are constructed using XML documents, enable more efficient and effective searching because of the well-known semantics of the standardised descriptors and description schemes used in MPEG-7. Nevertheless, MPEG-7 descriptions are expected to form only a (small) portion of all content descriptions available on the Web. It is desirable for MPEG-7 descriptions to be searchable and retrievable (or downloadable) in the same manner as other XML documents on the Web since users of the Web do not expect or want AV content to be downloaded with description. In some cases, the descriptions rather than the AV content are what may be required. In other cases, users will want to examine the description before deciding on whether to download or stream the content.

MPEG-7 descriptors and description schemes are only a sub-set of the set of (well-known) vocabulary used on the Web. Using the terminology of XML, the MPEG-7 descriptors and description schemes are elements and types defined in the MPEG-7 namespace. Further, Web users would expect that MPEG-7 elements and types could be used in conjunction with those of other namespaces. Excluding other widely used vocabularies and restricting all MPEG-7 descriptions to consist only of the standardised MPEG-7 descriptors and description schemes and their derivatives would make the MPEG-7 standard excessively rigid and unusable. A widely accepted approach is for a description to include vocabularies from multiple namespaces and to permit applications to process elements (from any namespace, including MPEG-7) that the application understands, and ignore those elements that are not understood.

To make downloading, and any consequential storing, of a multimedia (eg. MPEG-7) description more efficient, the descriptions can be compressed. A number of encoding formats have been proposed for XML, and include WBXML, derived from the Wireless Application Protocol (WAP). In WBXML, frequently used XML tags, attributes and values are assigned a fixed set of codes from a global code space. Application specific tag names, attribute names and some attribute values that are repeated throughout document instances are assigned codes from some local code spaces. WBXML preserves the structure of XML documents. The content as well as attribute values that are not defined in the Document Type Definition (DTD) can be stored in line or in a string table. An example of encoding using WBXML is shown in FIGS. 1A and 1B. FIG. 1A depicts how an XML source document 10 is processed by an interpreter 14 according various code spaces 12 defining encoding rules for WBXML. The interpreter 14 produces an encoded document 16 suitable for communication according to the WBXML standard. FIG. 1B provides a description of each token in the data stream formed by the document 16.

While WBXML encodes XML tags and attributes into tokens, no compression is performed on any textual content of the XML description. Such may be achieved using a traditional text compression algorithm, preferably taking advantage of the schema and data-types of XML to enable better compression of attribute values that are of primitive data-types.

### SUMMARY OF THE INVENTION

It is an object of the present invention to substantially overcome, or at least ameliorate, one or more disadvantages of existing arrangements to support the streaming of multimedia descriptions.

General aspects of the present invention provide for streaming descriptions, and for streaming descriptions with AV (audio-visual) content. When streaming descriptions with AV content, the streaming can be “description-centric” or “media-centric”. The streaming can also be unicast with upstream channel or broadcast.

According to a first aspect of the invention, there is provided a method of forming a streamed presentation from at least one media object having content and description components, said method comprising the steps of:

generating a presentation description from at least one component description of said at least one media object; and

processing said presentation description to schedule delivery of component descriptions and content of said presentation to generate elementary data streams associated with said component descriptions and content.

According to another aspect of the present invention there is disclosed a method of forming a presentation description for streaming content with description, said method comprising the steps of:

providing a presentation template that defines a structure of a presentation description;

applying said template to at least one description component of at least one associated media object to form said presentation description from each said description component, said presentation description defining a sequential relationship between description components desired for streamed reproduction and content components associated with said desired descriptions.

According to another aspect of the present invention there is disclosed a streamed presentation comprising a plurality of content objects interspersed amongst a plurality of description objects, said description objects comprising references to multimedia content reproducible from said content objects.

According to another aspect of the present invention there is disclosed a method of delivering an XML document, said method comprising the steps of:

dividing the document to separate XML structure from XML text; and

delivering said document in a plurality of data streams, at least one said stream comprising said XML structure and at least one other of said streams comprising said XML text.

In accordance with another aspect of the present invention, there is disclosed a method of processing a document described in a mark up language, said method comprising the steps of:

separating a structure and a text content of said document;

sending the structure before the text content; and

commencing to parse the received structure before the text content is received.

Other aspects of the present invention are also disclosed.

### BRIEF DESCRIPTION OF THE DRAWINGS

At least one embodiment of the present invention will now be described with reference to the drawings, in which:

FIGS. 1A and 1B show an example of a prior art encoding of an XML document;

FIG. 2 illustrates a first method of streaming an XML document;

FIG. 3 illustrates a second method of “description-centric” streaming in which the streaming is driven by a presentation description;

FIG. 4A illustrates a prior art stream;

FIG. 4B shows a stream according to one implementation of the present disclosure;

FIG. 4C shows a preferred division of a description stream;

FIG. 5 illustrates a third method of “media-centric” streaming;

FIG. 6 is an example of a composer application;

FIG. 7 is a schematic block diagram of a general purpose computer upon which the implementation of the present disclosure can be practiced; and

FIG. 8 schematically represents an MPEG-4 stream.

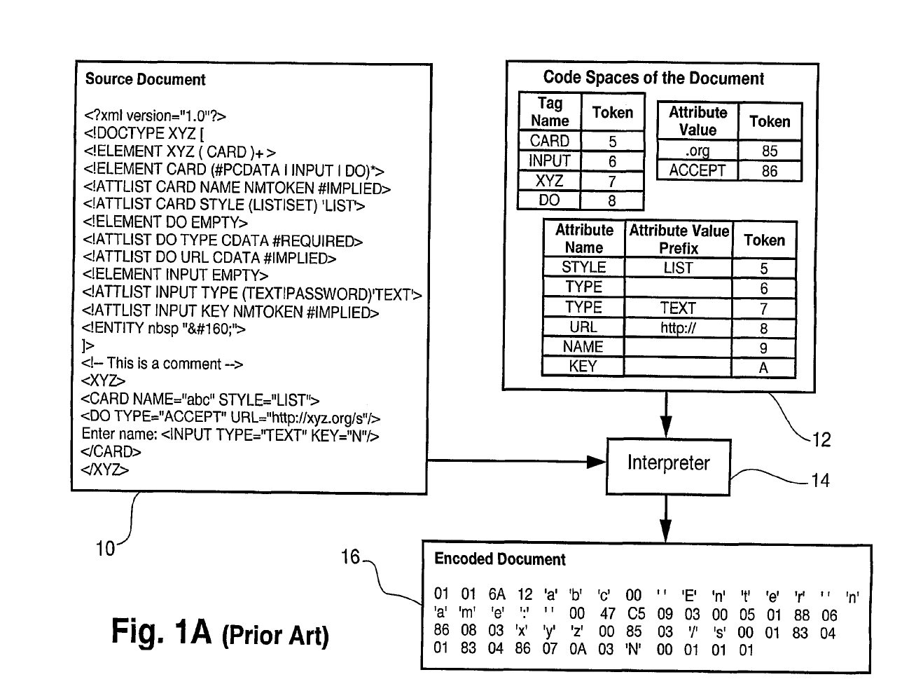

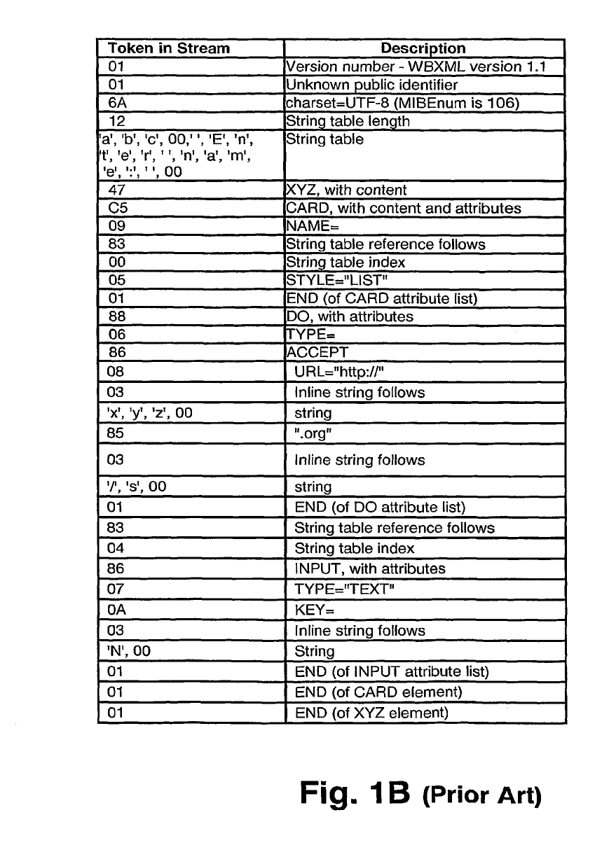

### DETAILED DESCRIPTION INCLUDING BEST MODE

The implementations to be described are each founded upon the relevant multimedia descriptions being XML documents. XML documents are mostly stored and transmitted in their raw textual format. In some applications, XML documents are compressed using some traditional text compression algorithms for storage or transmission, and decompressed back into XML before they are parsed and processed. Although compression may greatly reduce the size of an XML document, and thus reduce the time for reading or transmitting the document, an application still has to receive the entire XML document before the document can be parsed and processed. A traditional XML parser expects an XML document to be well-formed (ie. the document has matching and non-overlapping start-tag and end-tag pairs), and is unable to complete the parsing of the XML document until the whole XML document is received. Incremental parsing of a streamed XML document is unable to be performed using a traditional XML parser.

Streaming an XML document permits parsing and processing to commence as soon as a sufficient portion of the XML document is received. Such capability will be most useful in the case of a low bandwidth communication link and/or a device with very limited resources.

One way of achieving incremental parsing of an XML document is to send the tree hierarchy of an XML document (such as the Dominant Object Model (DOM) representation of the document) in a breadth-first or depth-first manner. To make such a process more efficient, the XML (tree) structure of the document can be separated from the text components of the document and encoded and sent before the text. The XML structure is critical in providing the context for interpreting the text. Separating the two components allows the decoder (parser) to parse the structure of the document more quickly, and to ignore elements that are not required or are unable to be interpreted. Such a decoder (parser) may optionally choose not to buffer any irrelevant text that arrives at a later stage. Whether the decoder converts the encoded document back into XML or not depends on the application.

The XML structure is vital in the interpretation of the text. In addition, as different encoding schemes are usually used for the structure and the text and, in general, there is far less structural information than textual content, two (or more) separate streams may be used for delivering the structure and the text.

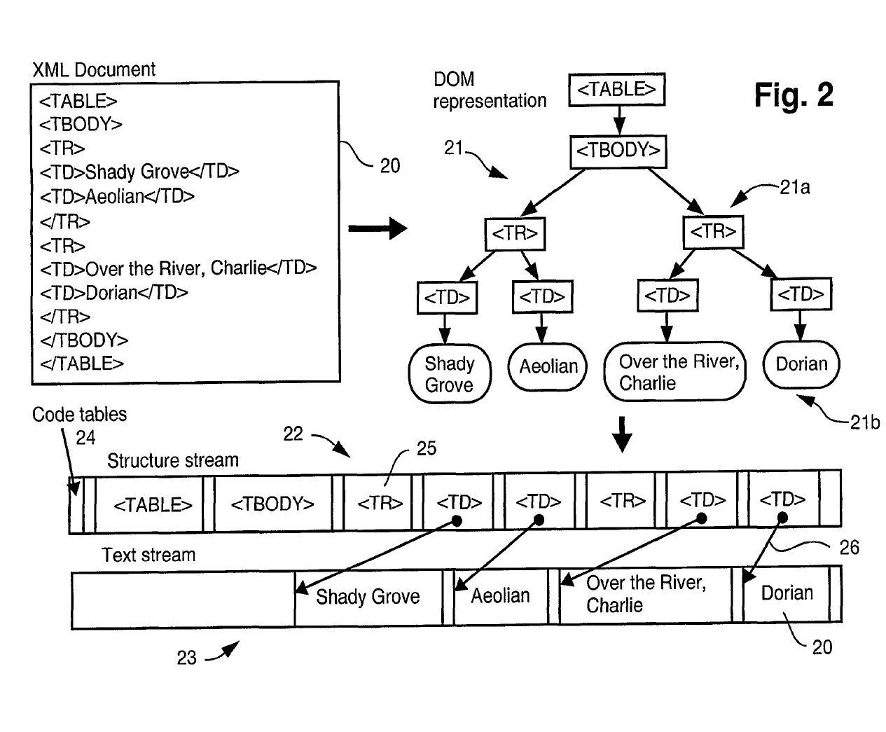

FIG. 2 shows one method of streaming XML document 20. Firstly, the document 20 is converted to a DOM representation 21, which is then streamed in a depth-first fashion. The structure of the document 20, depicted by the tree 21a of the DOM representation 21, and the text content 21b, are encoded as two separate streams 22 and 23 respectively. The structure stream 23 is headed by code tables 24. Each encoded node 25, representing a node of the DOM representation 21, has a size field that indicates its size including the total size of corresponding descendant nodes. Where appropriate, encoded leaf nodes and attribute nodes contain pointers 26 to their corresponding encoded content 27 in the text stream 23. Each encoded string in the text stream is headed by a size field that indicates the size of the string.

Not all multimedia (eg. MPEG-7) descriptions need be streamed with content or serve as a presentation. For instance, television and film archives store a vast amounts of multimedia material in several different formats, including analogue tapes. It would not be possible to stream the description of a movie, in which the movie is recorded on analogue tapes, with the actual movie content. Similarly, treating the multimedia description of a patient's medical records as a multimedia presentation makes little sense. As an analogy, while Synchronised Multimedia Integration Language (SMIL) presentations are themselves XML documents, not all XML documents are SMIL presentations. Indeed, only a very small number of XML documents are SMIL presentations. SMIL can be used for creating presentation script that enables a local processor to compile an output presentation from a number of local files or resources. SMIL specifies the timing and synchronisation model but does not have any built-in support for the streaming of content or description.

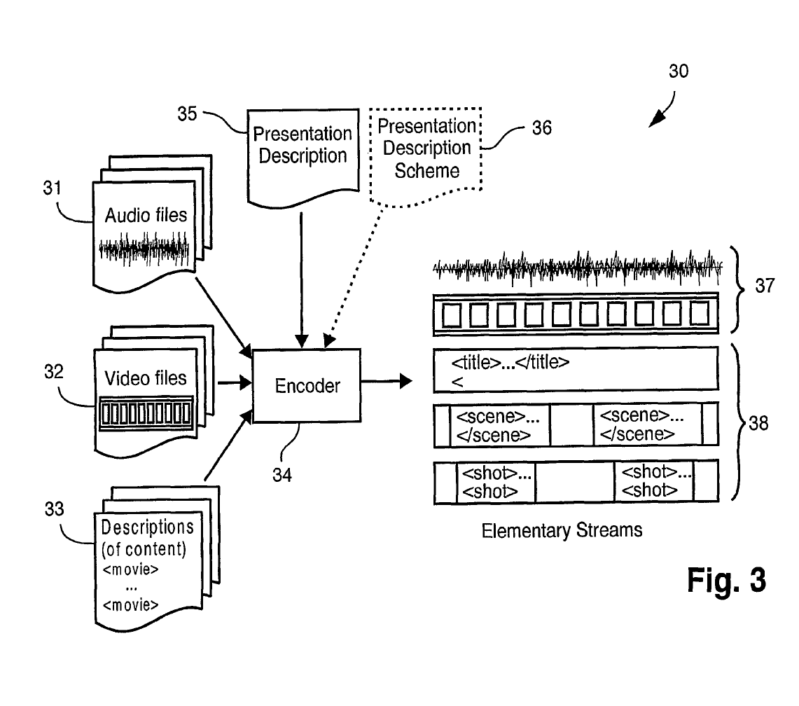

FIG. 3 shows an arrangement 30 for streaming descriptions together with content. A number of multimedia resources are shown including audio files 31 and video files 32. Associated with the resources 31 and 32 are descriptions 33 each typically formed of a number of descriptors and descriptor relationships. Significantly, there need not be a one-to-one relationship between the descriptions 33 and the content files 31 and 32. For example, a single description may relate to a number of files 31 and/or 32, or any one file 31 or 32 may have associated therewith more than one description.

As seen in FIG. 3, a presentation description 35 is provided to describe the temporal behaviour of a multimedia presentation desired to be reproduced through a method of description-centric streaming. The presentation description 35 can be created manually or interactively through the use of editing tools and a standardized presentation description scheme 36. The scheme 36 utilises elements and attributes to define the hyperlinks between the multimedia objects and the layout of the desired multimedia presentation. The presentation description 35 can be used to drive the streaming process. Preferably, the presentation description is an XML document that uses a SMIL-based description scheme.

An encoder 34, with knowledge of the presentation description scheme 36, interprets the presentation description 35, to construct an internal time graph of the desired multimedia presentation. The time graph forms a model of the presentation schedule and synchronization relationships between the various resources. Using the time graph, the encoder 34 schedules the delivery of the required components and then generates elementary data streams 37 and 38 that may be transmitted. Preferably, the encoder 34 splits the descriptions 33 of the content into multiple data streams 38. The encoder 34 preferably operates by constructing a URI table that maps the URI-references contained in the AV content 31, 32 and the descriptions 33 to a local address (eg. offset) in the corresponding elementary (bit) streams 37 and 38. The streams 37 and 38, having been transmitted, are received into a decoder (not illustrated) that uses the URI table when attempting to decode any URI-reference.

The presentation description scheme 36, in some implementations, may be based on SMIL. Current developments in MPEG-4 enable SMIL-based presentation description to be processed into MPEG-4 streams.

An MPEG-4 presentation is made up of scenes. An MPEG-4 scene follows a hierarchical structure called a scene graph. Each node of the scene graph is a compound or primitive media object. Compound media objects group primitive media objects together. Primitive media objects correspond to leaves in the scene graph and are AV media objects. The scene graph is not necessarily static. Node attributes (eg. positioning parameters) can be changed and nodes can be added, replaced or removed. Hence, a scene description stream may be used for transmitting scene graphs, and updates to scene graphs.

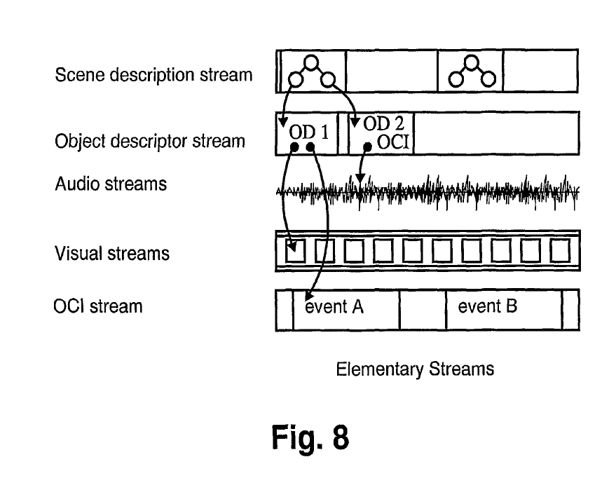

An AV media object may rely on streaming data that is conveyed in one or more elementary streams (ES). All streams associated to one media object are identified by an object descriptor (OD). However, streams that represent different content must be referenced through distinct object descriptors. Additional auxiliary information can be attached to an object descriptor in a textual form as an OCI (object content information) descriptor. It is also possible to attach an OCI stream to the object descriptor. The OCI stream conveys a set of OCI events that are qualified by their start time and duration. The elementary streams of an MPEG-4 presentation are schematically illustrated in FIG. 8.

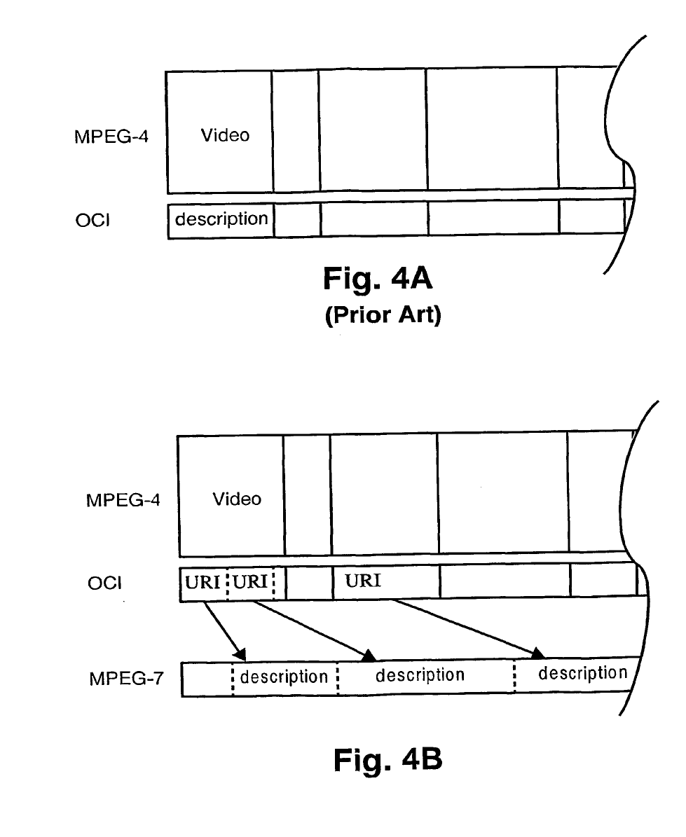

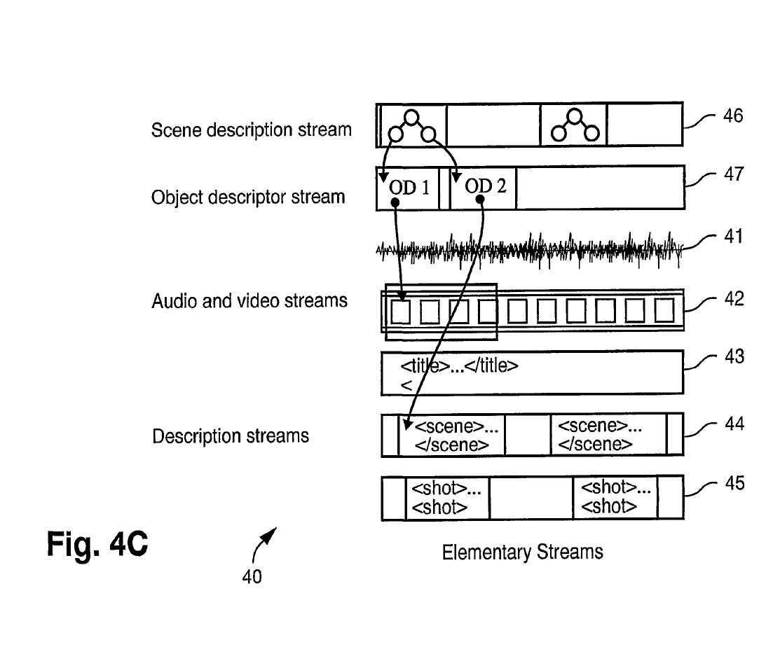

In MPEG-4, information about an AV object is stored and transmitted using the Object Content Information (OCI) descriptor or stream. The AV object contains a reference to the relevant OCI descriptor or stream. As seen in FIG. 4A, such an arrangement requires a specific temporal relationship between the description and the content and a one-to-one relationship between AV objects and OCI.

However, typically, multimedia (eg. MPEG-7) descriptions are not written for specific MPEG-4 AV objects or scene graphs and, indeed are written without any specific knowledge of the MPEG-4 AV objects and scene graphs that make up the presentation. The descriptions usually provide a high level view of the information of the AV content. Hence, the temporal scope of the descriptions might not align with those of the MPEG-4 AV objects and scene graphs. For instance, a video/audio segment described by an MPEG-7 description may not correspond to any MPEG-4 video/audio stream or scene description stream. The segment may describe the last portion of one video stream and the beginning part of the following one.

The present disclosure presents a more flexible and consistent approach in which the multimedia description, or each fragment thereof, is treated as another class of AV object. That is, like other AV objects, each description will have its own temporal scope and object descriptor (OD). The scene graph is extended to support the new (eg. MPEG-7) description node. With such a configuration, it is possible to send a multimedia (eg. MPEG-7) description fragment, that has sub-fragments of different temporal scopes, as a single data stream or as separate streams, regardless of the temporal scopes of the other AV media objects. Such a task is performed by the encoder 34 and a example of such a structure, applied to the MPEG-4 example of FIG. 4A, is shown in FIG. 4B. In FIG. 4B, the OCI stream is also used to contain references of relevant description fragments and other AV object specific information as required.

Treating MPEG-7 descriptions in the same way as other AV objects also means that both can be mapped to a media object element of the presentation description scheme 36 and subjected to the same timing and synchronisation model. Specifically, in the case of an SMIL-based presentation description scheme 36, a new media object element, such as an <mpeg7> tag, may be defined. Alternately, MPEG-7 descriptions can be treated as a specific type of text (eg. represented in Italics). Note that a set of common media object elements <video>, <audio>, <animation>, <text>, etc. are pre-defined in SMIL. The description stream can potentially be further separated into a structure stream and a text stream.

In FIG. 4C, a multimedia stream 40 is shown which includes an audio stream 41 and a video stream 42. Also included is a high-level scene description stream 46 comprising (compound or primitive) nodes of media objects and having leaf nodes (which are primitive media objects) that point to object descriptors ODn that make up an object descriptor stream 47. A number of low level description streams 43, 44 and 45 are also shown, each having components configured to be pointed to, or linked to the object description stream 47, as do the audio and video streams 41 and 42. With such an object-oriented streaming treating both content and description as media objects, the temporally irregular relationship between description and content may be accommodated through a temporal object description structured into the streams.

The above approach to streaming descriptions with content is appropriate where the description has some temporal relationship with the content. An example of this is a description of a particular scene in a movie, that provides for multiple camera angles to be viewed, thus permitting viewer access to multiple video streams for which only one video stream may, practically speaking, be viewed in the real-time running of the movie. This is to be contrasted with arbitrary descriptions which have no definable temporal relationship with the streamed content. An example of such may be a newspaper critic's text review of the movie. Such a review may make text reference, as opposed to a temporal and spatial reference to scenes and characters. Converting an arbitrary description into a presentation is a non-trivial (and often impossible) task. Most descriptions of AV content are not written with presentation in mind. They simply describe the content and its relationship with other objects at various levels of granularity and from different perspectives. Generating a presentation from a description that does not use the presentation description scheme 36 involves arbitrary decisions, best made by a user operating a specific application, as opposed to the systematic generation of the presentation description 35.

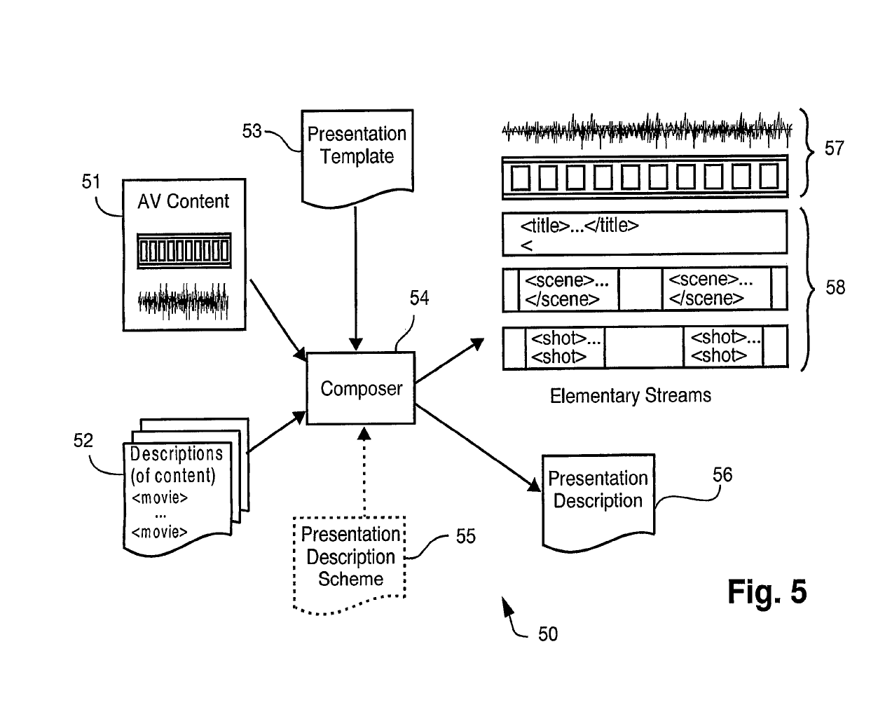

FIG. 5 shows another arrangement 50 for streaming descriptions with content that the present inventor has termed “media-centric”. AV content 51 and descriptions 52 of the content 51 are provided to a composer 54, also input with a presentation template 53 and having knowledge of a presentation description scheme 55. Although the content 51 shows a video and its audio track is shown as the initial AV media object, the initial AV object can actually be a multimedia presentation.

In media-centric streaming, an AV media object provides the AV content 51 and the timeline of the final presentation. This is in contrast to the description centric streaming where the presentation description provides the timeline of the presentation. Information relevant to the AV content is pulled in from a set of descriptions 52 of the content by the composer 54 and delivered with the content in a final presentation. The final presentation output from the composer 54 is in the form of elementary streams 57 and 58, as with the previous configuration of FIG. 3, or as a presentation description 56 of all the associated content.

The presentation template 53 is used to specify the type of descriptive elements that are required and those that should be omitted for the final presentation. The template 53 may also contain instructions as to how the required descriptions should be incorporated into the presentation. An existing language such as XSL Transformations (XSLT) may be used for specifying the templates. The composer 54, which may be implemented as a software application, parses the set of required descriptions that describe the content, and extracts the required elements (and any associated sub-elements) to incorporate the elements into the time line of the presentation. Required elements are preferably those elements that contain descriptive information about the AV content that is useful for the presentation. In addition, elements (from the same set of the descriptions) that are referred to (by IDREF's or URI-references) by the selected elements are also included and streamed before their corresponding referring elements (their “referrers”). It is possible that a selected element is in turn referenced (either directly or indirectly) by an element that it references. It is also possible that a selected element has a forward reference to another selected element. An appropriate heuristic may be used to determine the order by which such elements are streamed. The presentation template 53 can also be configured to avoid such situations.

The composer 54 may generate the elementary streams 57, 58 directly, or output the final presentation as the presentation description 56 that conforms to the known presentation description scheme 55.

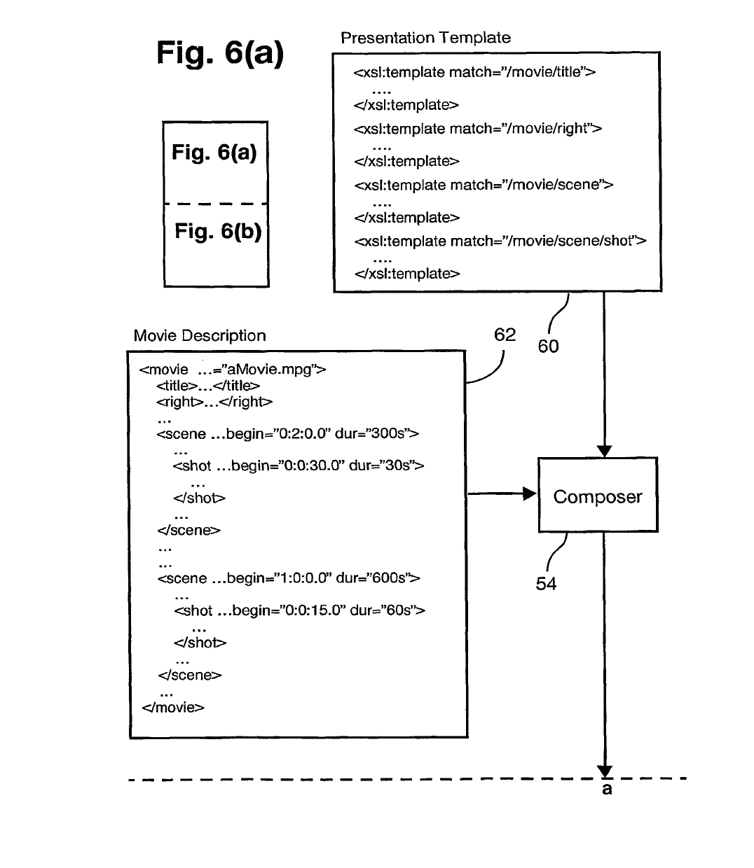

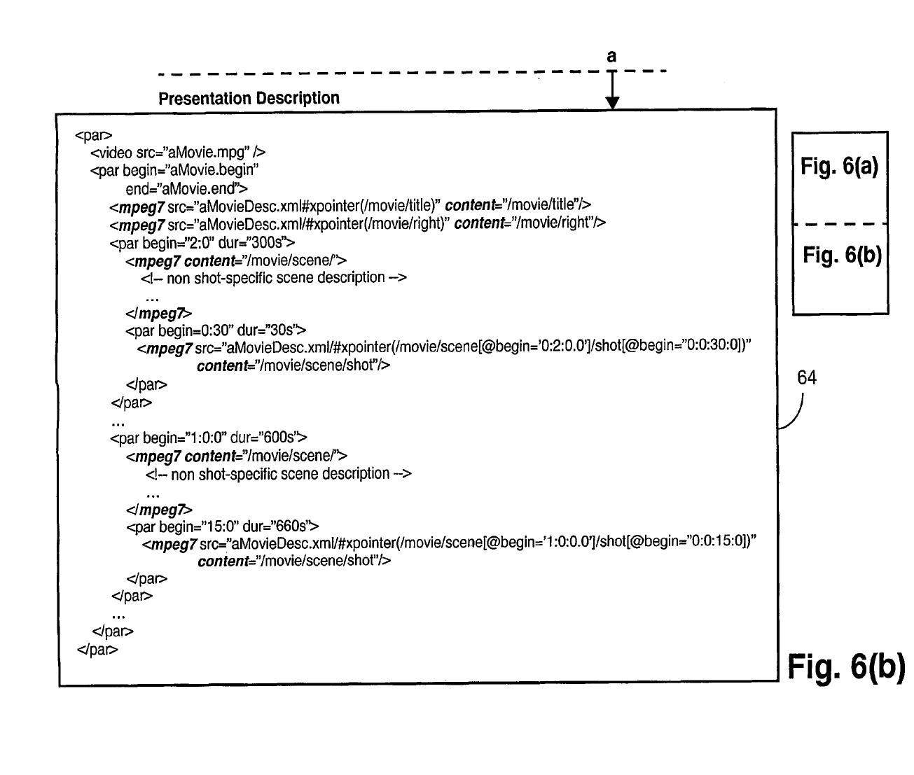

FIG. 6 is an example showing how the composer application 54 uses an XSLT-based presentation template 60 to extract the required description fragments from a movie description 62 to generate a SMIL-like presentation description 64 (or presentation script). The <par> container of SMIL specifies the start time and duration of a set of media objects that are to be presented in parallel. The <mpeg7> element shown in the presentation description 64 for example identifies the MPEG-7 description fragments. The description may be provided in-line or referred to by an URI reference. The src attribute contains an URI reference to the relevant description (fragment). The content attribute of the presentation description 64 describes the context of the included description. Special elements, such as an <mpeg7> tag, can be defined in the presentation description scheme 55 for specifying description fragments that can be streamed separately and/or at different times in the presentation description 64.

The use of the presentation description schemes 36 and 55, each as a multimedia presentation authoring language, bridges the two described methods of description-centric and media-centric streaming. The schemes 36 and 55 also allow for a clear separation between the application and the system layer to be made. Specifically, the composer application 54 of FIG. 5, when outputting the presentation as a (presentation) description 56 permits the description 56 be used as the input presentation description 35 in the arrangement of FIG. 3, thereby permitting an encoder 34 residing at the system layer to generate the required elementary streams 37, 38 from the presentation description 56.

In the case of streaming description with AV content, it is questionable whether a very efficient means of compressing the description is required as the size of the description is likely to be insignificant when compared to that of the AV content. Nevertheless, streaming of the description is still necessary because transmitting (and, in case of broadcasting, repeating) the entire description before the AV content may result in high latency and require a large buffer at the decoder.

For a description that forms part of a multimedia presentation, it may appear that the corresponding content changes along the presentation's timeline. The description, however, is not really “dynamic” (ie. it does not change with time). More correctly, different information from different descriptions or different parts of a description are being delivered and incorporated into the presentation at different times. Actually, if enough resources and bandwidth are available, all the “static” descriptions could be sent to the receiver at the same time for incorporating into a presentation at a later time. Nevertheless, the information delivered and presented during the presentation may be considered as generating a transient “dynamic” description.

If most of the information presented from one time instance to the next time instance remain unchanged, updates can be sent to effect the changes without repeating the unchanged information. The presented elements may be tagged with a begin time and a duration (or end time) just like other AV objects. Other attributes such as the position (or the context) of the element can also be specified. One possible approach is to use an extension of SMIL for specifying the timing and synchronization of the AV objects and the (fragments of) descriptions.

For example, the fragments of descriptions that go with a video clips of a soccer team may be specified according to Example 1 of SMIL-like XML code below:

### EXAMPLE 1

```
<!-- Description of the team is relevant during the team's video clip -->
<par begin=”teamAIntroductionVideo.begin” end=
”teamAIntroductionVideo.end”>
  <text src=”soccerTeam/teamA.xml#pointer(/soccerTeam/teamInfo)”
    context=”/soccerTeam/teamInfo”/>
  <!-- Descriptions of the players are presented.
      Each last for 15 seconds. -->
  <seq>
    <text src=”soccerTeam/teamA.xml#xpointer(/soccerTeam/player[1])”
      dur=”15s” context=”/soccerTeam/player”/>
    <text src=”soccerTeam/teamA.xml#xpointer(/soccerTeam/player[2])”
      dur=”15s” context=”/soccerTeam/player”/>
    ...
  </seq>
</par>
```

Updates to a “dynamic” description have to be applied with care. A partial update might leave the description in an inconsistent state. For video and audio, packets of data lost during transmission over the Web mostly appear as noise or even go unnoticed. However, inconsistent description may lead to wrong interpretations with serious consequences. For instance, in a weather report, if after the city element of a description is updated from “Tokyo” to “Sydney”, the update to the temperature element was lost, the description would report the temperature of Tokyo as the temperature of Sydney. As another example, if after updating the coordinates of an approaching aircraft in a streamed video game, the category element of the description is lost, a “friendly” aircraft might be mistakenly labelled as “hostile”.

As yet another example, shown in Example 2 below, an item number in a sale catalogue may become tagged with the wrong price. Hence, all related updates to a description have to be applied at once, or within a well-defined period, or not at all. For instance, in the following sales catalogue examples, every 10 seconds, the matching description and price of a new item is presented. The SMIL element par is used to hold all the related descriptive elements. A new sync attribute is used to make sure that matching description and price will be presented or not at all. The dur attribute makes sure that the information is applied for an appropriate period of time and then removed from the display.

### EXAMPLE 2

```
<!--
    A sales catalogue. Each item on sale is presented for 10 seconds.
    More complex synchronization model can be specified, for instance,
    the begin and end time of each par container can be synchronized
    with that of a video clip of the item.
-->
<seq>
  <par dur=”10s” sync=”true”>
    <text src=”products.xml#xpointer(/products/item[1]/description)”
      context=”/products/item/description”/>
    <text src=”products.xml#xpointer(/products/item[1]/price)”
      context=”/product/item/description”/>
  </par>
  <par dur=”10s” sync=”true”>
    <text src=”products.xml#xpointer(/products/item[2]/description)”
      context=”/products/item/description”/>
    <text src=”products.xml#xpointer(/products/item[2]/price)”
      context=”/products/item/price”/>
  </par>
  ...
</seq>
```

A streaming decoder has to buffer the synced set of elements and apply them as a whole. Missing information can be tolerated, as long as the incomplete information is consistent, and the sync attribute will not be required. In such cases, related elements can also be delivered and/or presented over a period of time. This can be demonstrated using Example 3 below:

### EXAMPLE 3

```
<!--
    A sales catalogue. Each item on sale is presented for 10 seconds.
    The price is only made available 3 seconds after its description.
    (N.B. timing information relating to a set of updates is only
    useful if the elements are mapped directly to text on the screen.)
-->
<seq>
  <par dur=”10s”>
    <text src=”products.xml#xpointer(/products/item[1]/description)”
      region=”description”
      context=”/products/item/description” />
    <text src=”products.xml#xpointer(/products/item[1]/price)”
      region=”price”
      context=”/products/item/price”
      begin=”3s” />
  </par>
  <par dur=”10s”>
    <text src=”products.xml#xpointer(/products/item[2]/description)”
      region=”description”
      context=”/products/item/description”/>
    <text src=”products.xml#xpointer(/products/item[2]/price)”
      region=”price”
      context=”/products/item/price”
      begin=”3s” />
  </par>
  ...
</seq>
```

It is extremely difficult, if not impossible, to decide at the system layer what updates to the document-tree are related and should be grouped without any hints from the description. Hence, while the system layer may allow updates to be grouped in the data streams and provide a means (such as the sync attribute in the above presentation description examples) to allow application to specify such grouping, the exact grouping should be left to the specific application.

If an upstream channel is available from the client to the server, the client can choose to signal the server for any lost or corrupted updated packets and request for their re-transmission, or ignore the entire set of updates.

In cases where the description is broadcast with AV content, the XML structure and text of the description should desirably be repeated at regular intervals throughout the duration that the description is relevant to the AV content. This allows the users to access (or tune into) the description at a time not predetermined. The description does not have to be repeated as frequently as the AV content because the description changes much less frequently and, at the same time, consumes significantly fewer computing resources at the decoder end. Nevertheless, the description should be repeated frequently enough so that users are able to use the description without perceptible delay after tuning into the broadcast program. If the description changes at about the same rate at which it is repeated, or at a lower rate, then it is questionable that the ability to “dynamically” update the description is important or actually required.

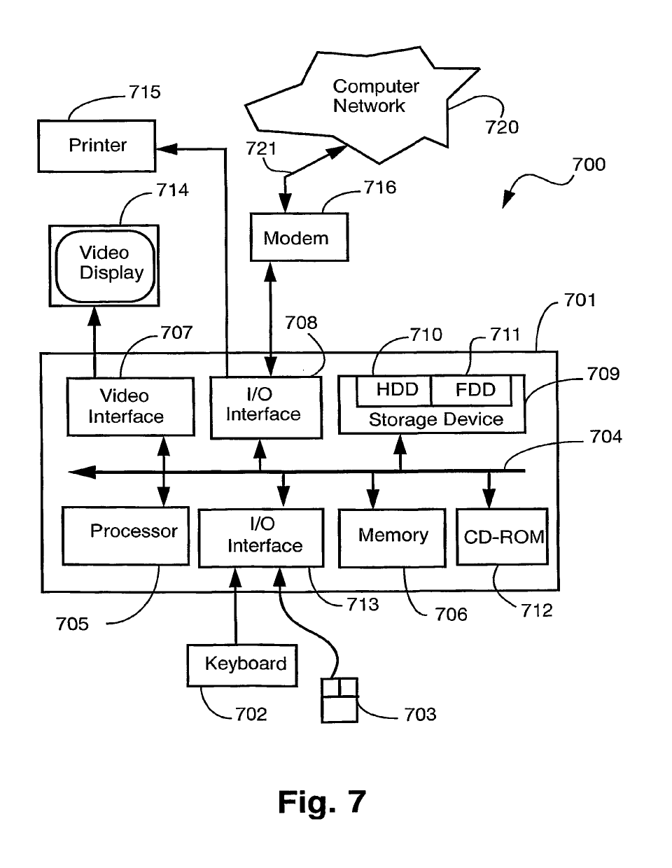

The methods of streaming descriptions with content described above may be practiced using a general-purpose computer system 700, such as that shown in FIG. 7 wherein the processes of FIGS. 2 to 6 may be implemented as software, such as an application program executing within the computer system 700. In particular, the steps of methods are effected by instructions in the software that are carried out by the computer. The software may be divided into two separate parts; one part for carrying out the encoding/composing/streaming methods; and another part to manage the user interface between the former and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for description with content streaming in accordance with the embodiments of the invention.

The computer system 700 comprises a computer module 701, input devices such as a keyboard 702 and mouse 703, output devices including a printer 715 and a display device 714. A Modulator-Demodulator (Modem) transceiver device 716 is used by the computer module 701 for communicating to and from a communications network 720, for example connectable via a telephone line 721 or other functional medium. The modem 716 can be used to obtain access to the Internet, and other network systems, such as a Local Area Network (LAN) or a Wide Area Network (WAN). It is via the device 716 that streamed multimedia may be broadcast or webcast from the computer module 701.

The computer module 701 typically includes at least one processor unit 705, a memory unit 706, for example formed from semiconductor random access memory (RAM) and read only memory (ROM), input/output (I/O) interfaces including a video interface 707, and an I/O interface 713 for the keyboard 702 and mouse 703 and optionally a joystick (not illustrated), and an interface 708 for the modem 716. A storage device 709 is provided and typically includes a hard disk drive 710 and a floppy disk drive 711. A magnetic tape drive (not illustrated) may also be used. A CD-ROM drive 712 is typically provided as a non-volatile source of data. The components 705 to 713 of the computer module 701, typically communicate via an interconnected bus 704 and in a mariner which results in a conventional mode of operation of the computer system 700 known to those in the relevant art. Examples of computer platforms on which the embodiments can be practised include IBM-PC's and compatibles, Sun Sparcstations or alike computer systems evolved therefrom, particularly when provided as a server incarnation.

Typically, the application program of the preferred embodiment is resident on the hard disk drive 710 and read and controlled in its execution by the processor 705. Intermediate storage of the program and any data fetched from the network 720 may be accomplished using the semiconductor memory 706, possibly in concert with the hard disk drive 710. The hard disk drive 710 and the CD-ROM 712 may form sources for the multimedia description and content information. In some instances, the application program may be supplied to the user encoded on a CD-ROM or floppy disk and read via the corresponding drive 712 or 711, or alternatively may be read by the user from the network 720 via the modem device 716. Still further, the software can also be loaded into the computer system 700 from other computer readable medium including magnetic tape, a ROM or integrated circuit, a magneto-optical disk, a radio or infra-red transmission channel between the computer module 701 and another device, a computer readable card such as a PCMCIA card, and the Internet and Intranets including e-mail transmissions and information recorded on websites and the like. The foregoing is merely exemplary of relevant computer readable media. Other computer readable media may be practiced without departing from the scope and spirit of the invention.

Some aspects of the streaming methods may be implemented in dedicated hardware such as one or more integrated circuits performing the functions or sub functions described. Such dedicated hardware may include graphic processors, digital signal processors, or one or more microprocessors and associated memories.

### INDUSTRIAL APPLICABILITY

It is apparent from the above that the embodiments of the invention are applicable to the broadcasting of multimedia content and descriptions and are of direct relevance to the computer, data processing and telecommunications industries.

The foregoing describes only some embodiments of the present invention, and modifications and/or changes can be made thereto without departing from the scope and spirit of the invention, the embodiments being illustrative and not restrictive.

1.-21. (canceled)

22. A method of processing a document described in a mark up language, said method comprising steps of:
separating a structure and a text content of said document;
sending the structure before the text content; and
commencing to parse the received structure before all of the text content is received.

23. The method according to claim 22, further comprising a step of ignoring received text content, if a result of parsing corresponding structure is found not to be required or is unable to be interpreted.

24. The method according to claim 23, wherein said ignoring step includes inhibiting a buffering of the text to be ignored.

25. The method according to claim 22, wherein the mark up language is XML.

26. The method according to claim 22, wherein said separating step includes encoding the structure and the text content as two separate streams.

27. The method according to claim 26, wherein said document is formed as a tree hierarchy representation and said separating step includes interpreting said document in a depth-first fashion to form said two separate streams.

28. The method according to claim 26, wherein said document is formed as a tree hierarchy representation and said separating step includes interpreting said document in a breadth-first fashion to form said two separate streams.

29.-33. (canceled)
